(19) United States
(12) Patent Application Publication
(10) Pub. No.: US 2024/0356677 A1
(43) Pub. Date: Oct. 24, 2024

(54) METHOD, DEVICE AND COMPUTER STORAGE MEDIUM OF COMMUNICATION

(71) Applicant: NEC CORPORATION, Tokyo (JP)

(72) Inventors: Xiaohong ZHANG, Beijing (CN); Gang WANG, Beijing (CN)

(73) Assignee: NEC CORPORATION, Tokyo (JP)

(21) Appl. No.: 18/292,769

(22) PCT Filed: Jul. 27, 2021
(86) PCT No.: PCT/CN2021/108736

§ 371 Date: Jan. 26, 2024

(51) Int. Cl. H04L 1/1812; H04L 1/1867; H04W 72/0446; H04W 72/231

(52) U.S. Cl. CPC H04L 1/1812; H04L 1/1887; H04W 72/0446; H04W 72/231

(57) ABSTRACT

Embodiments of the present disclosure relate to methods, devices and computer readable media for communication. A terminal device comprise a processor configured to perform: receiving, from a network device, information indicating a first resource for initial transmission of a first HARQ feedback for a first data transmission; receiving, from the network device, a first DCI indicating a second resource for retransmission of the first HARQ feedback; receiving, from the network device, a second DCI indicating a third resource for initial transmission of a second HARQ feedback for a second data transmission scheduled later than the first data transmission, wherein a priority of the first HARQ feedback is the same as a priority of the second HARQ feedback; and transmitting, to the network device, the first HARQ feedback on the second resource. In this way, the spectrum efficiency and system performance can be improved.

### TECHNICAL FIELD

Embodiments of the present disclosure generally relate to the field of telecommunication, and in particular, to methods, devices and computer storage media of enhancement on a Hybrid Automatic Repeat Request acknowledgement (HARQ-ACK) codebook.

### BACKGROUND

Downlink control information (DCI) is widely used by a base station (e.g., gNB) for scheduling various data transmissions or services on a Physical Downlink Shared Channel (PDSCH). Upon decoding the DCI, a terminal device (e.g., UE) can receive the transmission and then transmit a corresponding HARQ feedback for the transmission on a Physical Uplink Control Channel (PUCCH). In some cases, a transmission of a HARQ feedback on a PUCCH resource may be canceled or dropped. For example, if a PUCCH resource for a low priority HARQ feedback is overlapped with a PUCCH resource for a high priority HARQ feedback, the high priority HARQ feedback will be transmitted while the low priority HARQ feedback is dropped. For another example, in case of time division duplex (TDD) system, if a configured grant (CG) PUCCH resource for a Semi-Persistent Scheduling (SPS) HARQ feedback collides with DL symbols, the transmission of SPS HARQ feedback will be cancelled. In addition, when a HARQ feedback is multiplexed on a PUSCH resource that is cancelled by a UL cancelling indication from the gNB, the transmission of the HARQ feedback will be necessarily canceled.

In the above cases, when the gNB does not receive the HARQ feedback for the data transmission, instead of retransmitting the data transmission directly, it is expected to trigger a retransmission of the cancelled HARQ feedback. This would be beneficial to the spectrum efficiency of the communication system.

### SUMMARY

In general, embodiments of the present disclosure provide methods, devices and computer storage media for an enhanced HARQ feedback mechanism.

In a first aspect, there is provided a method of communication. The method comprises: receiving, at a terminal device and from a network device, information indicating a first resource for initial transmission of a first Hybrid Automatic Repeat Request (HARQ) feedback for a first data transmission; receiving, from the network device, a first downlink control information (DCI) indicating a second resource for retransmission of the first HARQ feedback; receiving, from the network device, a second downlink control information (DCI) indicating a third resource for initial transmission of a second HARQ feedback for a second data transmission scheduled later than the first data transmission, wherein a priority of the first HARQ feedback is the same as a priority of the second HARQ feedback; and transmitting, to the network device, the first HARQ feedback on the second resource.

In a second aspect, there is provided a method of communication. The method comprises: transmitting, at a network device and to a terminal device, an information indicating a first resource for initial transmission of a first Hybrid Automatic Repeat Request (HARQ) feedback for a first data transmission; in accordance with a determination that the first resource for the first HARQ feedback is to be cancelled, transmitting, to the terminal device, a first downlink control information (DCI) indicating a second resource for retransmission of the first HARQ feedback; transmitting, to the terminal device, a second downlink control information (DCI) indicating a third resource for initial transmission of a second HARQ feedback for a second data transmission scheduled later than the first data transmission, wherein a priority of the first HARQ feedback is the same as a priority of the second HARQ feedback; and receiving, from the terminal device, the first HARQ feedback on the second resource.

In a third aspect, there is provided a terminal device. The terminal device comprises a processor and a memory coupled to the processor. The memory stores instructions that when executed by the processor, cause the terminal device to perform the method according to the first aspect of the present disclosure.

In a fourth aspect, there is provided a network device. The network device comprises a processor and a memory coupled to the processor. The memory stores instructions that when executed by the processor, cause the network device to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2A illustrates a schematic diagram illustrating an out-of-order HARQ feedback retransmission according to embodiments of the present disclosure;

FIG. 2B illustrates a schematic diagram illustrating an example of HARQ feedback retransmission according to embodiments of the present disclosure;

FIG. 2C illustrates a schematic diagram illustrating another example of HARQ feedback retransmission according to embodiments of the present disclosure;

FIG. 3A illustrates a schematic diagram illustrating an example of multiplexing HARQ feedback retransmission and initial HARQ feedback transmission on the same PUCCH resource according to embodiments of the present disclosure;

FIG. 3B illustrates a schematic diagram illustrating an example multiplexed type-1 HARQ codebook including respective sub-codebooks for HARQ feedback retransmission and initial HARQ feedback.

FIG. 3C illustrates a schematic diagram illustrating an example multiplexed type-1 HARQ codebook according to embodiments of the present disclosure;

FIG. 4A illustrates a schematic diagram illustrating another example of multiplexing HARQ feedback retransmission and initial HARQ feedback transmission on the same PUCCH resource according to embodiments of the present disclosure;

FIG. 4B illustrates a schematic diagram illustrating an example multiplexed type-2 HARQ codebook according to embodiments of the present disclosure;

FIG. 4C illustrates a schematic diagram illustrating an example of multiplexing HARQ feedback retransmissions on the same PUCCH resource according to embodiments of the present disclosure;

FIG. 5 illustrates a schematic diagram illustrating an example of SPS HARQ feedback retransmission according to embodiments of the present disclosure;

FIG. 6 illustrates a schematic diagram illustrating another example of SPS HARQ feedback retransmission according to embodiments of the present disclosure;

FIG. 7 illustrates a schematic diagram illustrating a process of HARQ feedback retransmission according to embodiments of the present disclosure;

FIG. 8 illustrates another example method of communication implemented at a terminal device in accordance with some embodiments of the present disclosure;

FIG. 9 illustrates another example method of communication implemented at a network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As discussed above, retransmission of the cancelled HARQ feedback is expected to be supported in the communication system. The triggering of such HARQ feedback retransmission can be implemented in a one-shot manner. For example, the HARQ feedback retransmission can be triggered by a dynamic DL assignment from the gNB. Additionally, or alternatively, in a case of SPS transmission, the UE can defer the transmission of the HARQ feedback that collides with DL symbols until a next available PUCCH occasion.

Currently, regarding the out of order of HARQ-ACK condition, there is no scheme for arrangement of the order of the PUCCH resource for HARQ feedback retransmission and the PUCCH resource for initial HARQ feedback transmissions, which is also called new transmitted HARQ-ACK. Moreover, it is expected to support multiplexing of the retransmitted HARQ-ACK for a DL data transmission and initial HARQ-ACK for other DL data transmission in a same HARQ-ACK codebook and transmitted on a PUCCH resource to reduce the PUCCH transmissions, which is effective. While the HARQ-ACK codebook construction of initial HARQ-ACK and retransmitted HARQ-ACK needs to be studied. To this end, a HARQ-ACK codebook suitable for such HARQ-ACK retransmission and possible multiplexing also needs to be designed.

Embodiments of the present disclosure provide solutions for solving the above and other potential issues. Generally, an enhanced HARQ feedback mechanism is provided to facilitate the communication between the terminal device and the network device. The mechanism provides a clear definition for out-of-order HARQ-ACK condition for two PUCCH resources for retransmitted HARQ-ACK and new transmitted HARQ-ACK. It also provides a solution for UE to determine the priority between dynamic SPS HARQ-ACK retransmission triggering and semi-static SPS HARQ-ACK deferral rule. Moreover, the HARQ-ACK retransmission for one data transmission can be multiplexed with at least one of HARQ retransmission or initial HARQ-ACK transmission for other data transmissions in the same codebook, and thus less PUCCH transmissions can be achieved. In this way, the spectrum efficiency and system performance can be improved, while an improved multiplexed HARQ-ACK codebook construction method is provided to reduce the overhead for UCI.

Principles and implementations of the present disclosure will be described in detail below with reference to the figures.

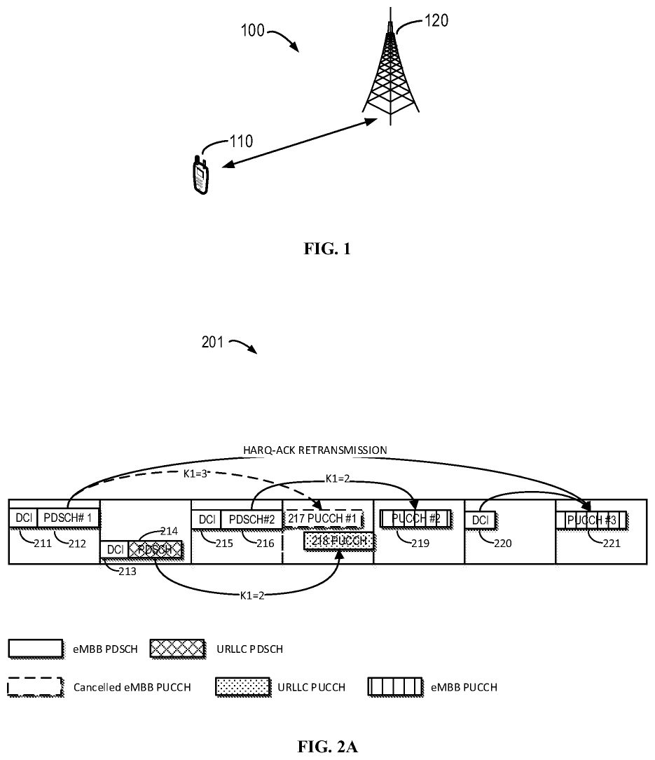

FIG. 1 illustrates a schematic diagram of an example communication network 100 in which some embodiments of the present disclosure can be implemented. As shown in FIG. 1, the communication network 100 may include a terminal device 110 and a network device 120. In some embodiments, the terminal device 110 may be served by the network device 120. It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

As shown in FIG. 1, the terminal device 110 may communicate with the network device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

The terminal device 110 may transmit uplink data to the network device 120 via an uplink data channel transmission. For example, the uplink data channel transmission may be a PUSCH transmission. Of course, any other suitable forms are also feasible. In some embodiments, the terminal device 110 may receive downlink data from the network device 120 via a downlink data channel transmission. For example, the downlink data channel transmission may be a PDSCH transmission. Of course, any other suitable forms are also feasible.

The terminal device 110 may receive DCI indicative of data transmission configuration from the network device 120 via a downlink control channel transmission. For example, the downlink control channel transmission may be a PDCCH transmission. Of course, any other suitable forms are also feasible.

The terminal device 110 may transmit UCI, e.g., HARQ feedback information to the network device 120 via an uplink channel transmission. For example, the uplink channel transmission may be a PUCCH or PUSCH transmission. Of course, any other suitable forms are also feasible.

The network device 120 may be able to provide a plurality of serving cells (not shown herein) for the terminal device 110, for example, a primary cell (PCell), a primary secondary cell (PSCell), a secondary cell (SCell), a special cell (sPCell) or the like. Each of the serving cells may correspond to a CC. The terminal device 110 may perform transmission with the network device 120 via a CC. The terminal device 110 may also perform transmission with the network device 120 via multiple CCs, for example, in case of carrier aggregation (CA). The network device 120 may schedule downlink data transmissions via different CCs in various manners.

Upon receipt of data transmissions from the network device 120, the terminal device 110 then generates and transmits a HARQ-ACK codebook comprising HARQ feedbacks for the data transmissions.

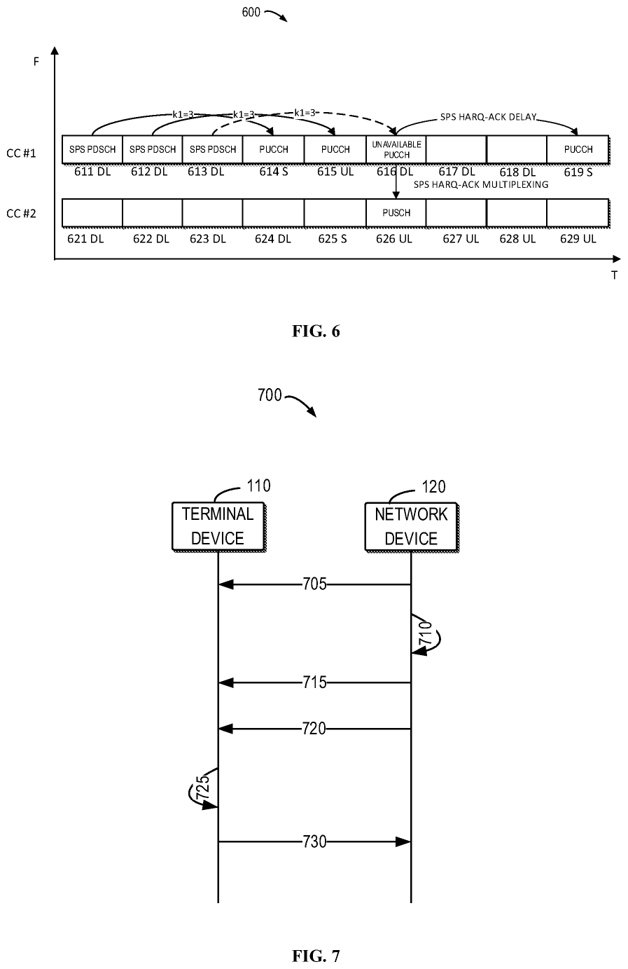

To better understand the enhanced HARQ feedback mechanism proposed in the disclosure, reference is now made to FIG. 7. FIG. 7 illustrates a schematic diagram illustrating a process 700 of HARQ feedback retransmission according to embodiments of the present disclosure. The process 700 as shown in FIG. 7 involves the terminal device 110 and the network device 120 as shown in FIG. 1. For the purpose of discussion, the process 700 will be described with reference to FIG. 1. It is to be understood that the process 700 may include additional operations not shown and/or may omit some operations as shown, and the scope of the present disclosure is not limited in this regard.

As shown in FIG. 7, the network device 120 transmits 705, to the terminal device 110, information indicating a first resource for initial transmission of a HARQ feedback for a first data transmission. The first data transmission may comprise a semi-persistent scheduling (SPS) transmission or a dynamic scheduled downlink transmission.

If the network device 120 determines 710 that the first resource for the first HARQ feedback is to be cancelled by the terminal device 110, the network device 120 transmits 715 a first DCI indicating a second resource for retransmission of the first HARQ feedback to the terminal device 110.

The network device 120 transmits 720 a second DCI indicating a third resource for initial transmission of a second HARQ feedback for a second data transmission to the terminal device 110. The second data transmission is scheduled later than the first data transmission, and a priority of the first HARQ feedback is the same as a priority of the second HARQ feedback.

Generally, the terminal devices in a given cell, e.g., the terminal device 110, are not expected to receive a first PDSCH and a second PDSCH that starts later than the first PDSCH, with its corresponding HARQ-ACK assigned to be transmitted on a resource ending before the start of a different resource for the HARQ-ACK assigned to be transmitted for the first PDSCH, where the two resources are in different slots for the associated HARQ-ACK transmissions, and the HARQ-ACK for the two PDSCHs are associated with the HARQ-ACK codebook of the same priority. This is the so-called out-of-order rule for transmission of HARQ feedbacks. Hence, the terminal device 110 should have no confusion on resources for initial HARQ-ACK transmission and HARQ-ACK retransmission when determining whether the out-of-order HARQ-ACK rule is met.

In some example embodiments, the third resource is expected to be transmitted later than the first resource, no matter whether the third resource is earlier or later than the second resource. In these embodiments, when determining whether the out-of-order rule is met for retransmitted HARQ-ACK transmission for a DL data transmission and initial HARQ-ACK transmission for other DL data transmission transmitted later, the terminal device 110 may regard the initial PUCCH resource (i.e., the first resource) on which the initial HARQ-ACK transmission is cancelled as the resource for HARQ-ACK retransmission for out-of-order HARQ-ACK condition. Thus, as long as the initial PUCCH resource for cancelled HARQ-ACK for an earlier data transmission is transmitted no later than the PUCCH resource for the initial valid HARQ-ACK transmission for a later data transmission, the out-of-order HARQ-ACK rule will be met.

Additionally or Alternatively, in the above embodiments, when determining whether the out-of-order rule is met for a retransmitted HARQ-ACK transmission for a DL data transmission and another retransmitted HARQ-ACK transmission for other DL data transmission transmitted later, the terminal device 110 may expect the PUCCH resource for HARQ-ACK retransmission to be triggered and transmitted no later than the PUCCH resource for HARQ-ACK retransmission for DL data transmitted later.

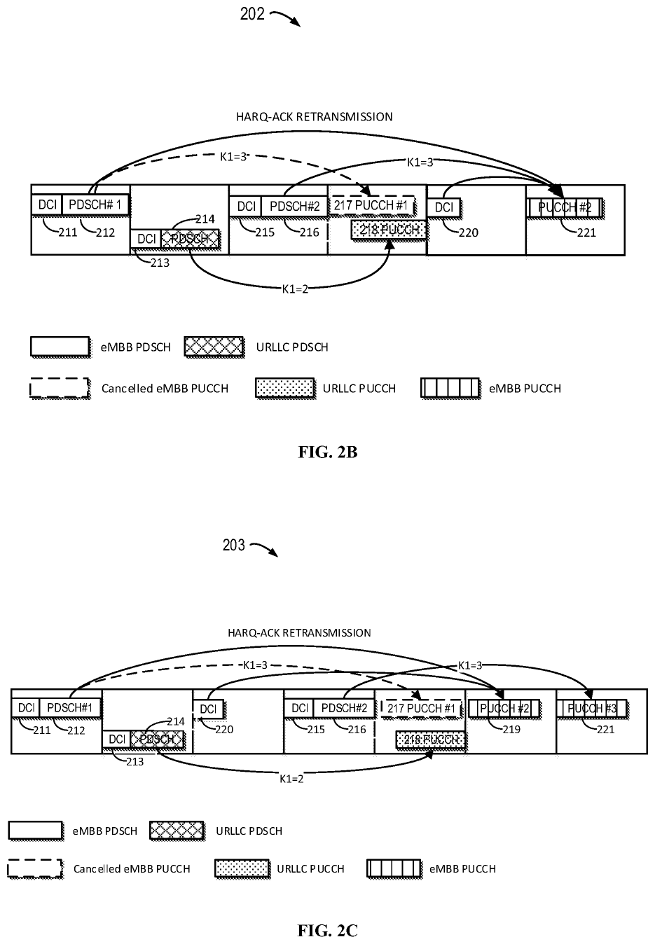

FIG. 2A illustrates a schematic diagram illustrating an out-of-order HARQ feedback retransmission 201 according to embodiments of the present disclosure. As shown in FIG. 2A, the network device 120 transmits DCI 211 and PDSCH #1 212, the DCI 213 and PDSCH 214, and DCI 215 and PDSCH #2 216 in sequence to the terminal device 110. The initial transmissions of HARQ feedbacks for the PDSCHs 212 and 214 are supposed to be transmitted on PUCCH #1 217 and PUCCH 218. Since the PUCCH #1 217 with a low priority for enhanced mobile broadband (cMBB) PDSCH 212 is overlapped with the PUCCH 218 with a high priority for ultra reliable and low latency communication (URLLC) PDSCH 214, the initial transmission of the HARQ feedback on PUCCH #1 217 is cancelled. Moreover, the initial transmission of HARQ feedback for PDSCH #2 216 that also belongs to the eMBB service is to be scheduled on PUCCH #2 219. Since the network device 120 is aware of the cancellation of PUCCH #1 217, the network device 120 then transmits DCI 220 for triggering the HARQ-ACK retransmission on PUCCH #3 221. Upon receipt of the DCI 220, the terminal device 110 determines that the PUCCH #1 217 is transmitted before the PUCCH #2 219 for the PDSCH #2, and then determines that the out-of-order HARQ-ACK rule is met.

To avoid violation of the out-of-order HARQ-ACK rule, the network device 120 may select a PUCCH resource transmitted later than the PUCCH #1 217 to transmit initial HARQ-ACK transmission for PDSCH #2 216. For example, the PUCCH #2 219 per se or any other PUCCH transmitted earlier than the PUCCH #2 219 may be selected. The network device 120 may then transmit the DCI 220 for indicating the PUCCH #2 219.

In some other example embodiments, the third resource may be expected to be transmitted not earlier than the second resource. Thus, as long as the PUCCH resource for the HARQ-ACK retransmission (i.e., the second resource) is transmitted no later than the PUCCH resource for the initial HARQ-ACK transmission for a later data transmission, the out-of-order HARQ-ACK rule will be met. That means the actual PUCCH resource for HARQ-ACK transmission is used for out-of-order HARQ-ACK condition.

In these embodiments, the resource determination for the HARQ-ACK retransmission performed at the network device 120 may be based on the above rule. FIG. 2B illustrates a schematic diagram illustrating an example of HARQ feedback retransmission 202 according to embodiments of the present disclosure. As shown in FIG. 2B, the network device 120 transmits the DCI 211 and PDSCH #1 212, the DCI 213 and PDSCH 214, and DCI 215 and PDSCH #2 216 in sequence to the terminal device 110. The initial transmissions of HARQ feedbacks for the PDSCHs 212 and 214 are supposed to be transmitted on PUCCH #1 217 and PUCCH 218. Since the PUCCH #1 217 with a low priority for cMBB PDSCH 212 is overlapped with the PUCCH 218 with a high priority for URLLC PDSCH 214, the initial transmission of the HARQ feedback on PUCCH #1 217 is cancelled. Moreover, the initial transmission of HARQ feedback for PDSCH #2 216 that also belongs to the eMBB service is to be scheduled on PUCCH #2 221. To avoid violation of the out-of-order HARQ-ACK rule, the network device 120 may select a PUCCH resource transmitted no later than the PUCCH #2 221 to retransmit HARQ-ACK for PDSCH #1 212. For example, the PUCCH #2 221 per se or any other PUCCH transmitted earlier than the PUCCH #2 221 may be selected. The network device 120 may then transmit the DCI 220 for indicating the PUCCH #2 221.

In some other example embodiments, to avoid violation of the out-of-order HARQ-ACK rule, after determining the cancellation of HARQ feedback on a PUCCH resource, the network device 120 may triggering the DCI for scheduling the HARQ-ACK retransmission immediately or prior to sending any DCI for scheduling other data transmissions. FIG. 2C illustrates a schematic diagram illustrating another example of HARQ feedback retransmission 203 according to embodiments of the present disclosure.

As shown in FIG. 2C, the network device 120 transmits the DCI 211 and PDSCH #1 212, the DCI 213 and PDSCH 214, and DCI 215 and PDSCH #2 216 in sequence to the terminal device 110. The initial transmissions of HARQ feedbacks for the PDSCHs 212 and 214 are supposed to be transmitted on PUCCH #1 resource 217 and PUCCH resource 218. Since the PUCCH #1 217 with a low priority for cMBB PDSCH 212 is overlapped with the PUCCH 218 with a high priority for URLLC PDSCH 214, the initial transmission of the HARQ feedback on PUCCH #1 resource 217 is cancelled. The network device 120 may then transmit the DCI 220 for triggering the HARQ-ACK retransmission before any other DCI (e.g., DCI 215) for scheduling later PDSCH #2 216 that belongs to the eMBB service. Hence, the HARQ-ACK retransmission on PUCCH #2 219 as indicated by the DCI 220 is inherently earlier than the initial HARQ-ACK transmission on PUCCH #3 221 as indicated by the DCI 215.

In some other embodiments, it is specified that HARQ-ACK retransmission and initial HARQ-ACK transmission cannot be multiplexed on a PUCCH resource. For example, if the terminal device 110 determine that the second resource and the third resource are the same or overlapped in time domain, the initial transmission of the second HARQ feedback on the third resource may be cancelled. Alternatively, the HARQ-ACK retransmission on the second resource may be cancelled. For another example, the terminal device 110 doesn't expect that HARQ-ACK for new scheduled PDSCH is indicated to be transmitted in the slot/sub-slot for PUCCH for re-transmitted. In other words, the network device 120 may avoid scheduling the HARQ-ACK retransmission and initial HARQ-ACK transmission on the same PUCCH.

Upon receipt of the information, the first DCI and the second DCI, the terminal device 110 generates 725 a first HARQ feedback. The first HARQ feedback may be included in a HARQ-ACK codebook which may also include at least one HARQ feedback for other data transmissions. In other words, the HARQ-ACK retransmission may be multiplexed with initial HARQ-ACK retransmission (e.g., the second HARQ feedback) or additional HARQ-ACK retransmissions.

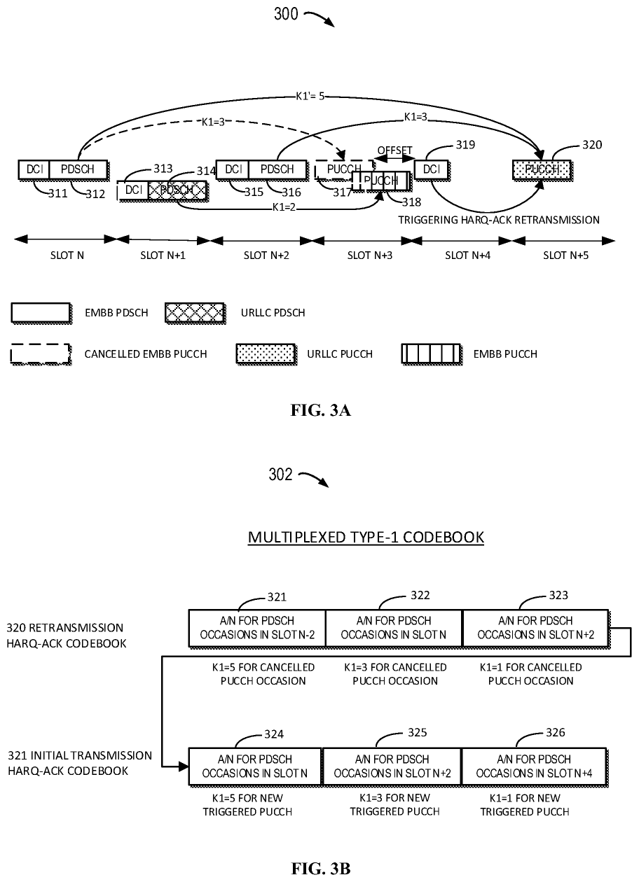

The terminal device 110 transmits 730, to the network device 120, the first HARQ feedback on the second resource. FIG. 3A illustrates a schematic diagram illustrating an example of multiplexing HARQ feedback retransmission and initial HARQ feedback transmission on the same PUCCH resource according to embodiments of the present disclosure. As shown in FIG. 3A, the network device 120 transmits DCI 311 and PDSCH 312, DCI 313 and PDSCH 314, and DCI 315 and PDSCH 316 in sequence to the terminal device 110. The initial transmissions of HARQ feedbacks for the PDSCHs 312 and 314 are supposed to be scheduled on PUCCH 317 and PUCCH 318. Since the PUCCH 317 with a low priority for HARQ-ACK for at least eMBB PDSCH 312 is overlapped with the PUCCH 318 with a high priority for HARQ-ACK for at least URLLC PDSCH 314, the initial transmission of the HARQ feedback on PUCCH 317 is cancelled.

The network device 120 then transmits DCI 319 indicating PUCCH 320 for the HARQ-ACK retransmission for PDSCH 312. Moreover, the initial HARQ-ACK transmission for PDSCH 316 is also indicated to be transmitted on PUCCH 320. In this case, the terminal device 110 may construct the HARQ-ACK codebook comprising at least the HARQ-ACK retransmission for PDSCH 312 and the initial HARQ-ACK transmission for PDSCH 316. In other words, the retransmitted HARQ-ACK and the initial HARQ-ACK are multiplexed on the same PUCCH 320.

The HARQ-ACK codebook may be a type-1 or type-2 HARQ-ACK codebook and may be constructed in various ways. FIG. 3B illustrates a schematic diagram illustrating an example multiplexed type-1 HARQ codebook 302 including respective HARQ-ACK codebooks 320 and 321 for retransmitted HARQ feedback and initial HARQ feedback as shown in FIG. 3A. As shown in FIG. 3B, a set of K1 values associated with the low priority PUCCH for the eMBB service is {1, 3, 5}, and a set of K1 values associated with the high priority PUCCH for the URLLC service is {1, 2}. Table 1 shows an example time domain resource allocation (TDRA) list associated with both low and high priority PUCCHs configured for the terminal device 110.

TABLE 1
TDRA list

| RI index | Start indicator | Length indicator |
|---|---|---|
| 0 | 0 | 2 |
| 1 | 3 | 7 |
| 2 | 9 | 5 |

Based on the TDRA list and the set of K1 values, the terminal device 110 may simply generate a first HARQ-ACK codebook 320 for retransmitted HARQ-ACK on PUCCH 317 and a second HARQ-ACK codebook 321 for initial HARQ-ACK on PUCCH 325, with the first HARQ-ACK codebook 320 preceding the second HARQ-ACK codebook 321. Each of the HARQ-ACK codebooks 320 and 321 includes a plurality of HARQ bits 321 to 326. Although the type-1 HARQ-ACK codebook construction method as shown in FIG. 3B is simple, it is not quite desirable in terms of resource efficiency and system performance. In particular, some of the DL slots within the HARQ-ACK multiplexing window based on the K1 set and the slot for the PUCCH 317 and the PUCCH 325 are the same, i.e., slot N and slot N+2, so the HARQ-ACK positions for PDSCH occasions in slot N and slot N+2 are actually generated twice in the multiplexed HARQ-ACK codebook 302. Based on the TDRA list, 3 PDSCH occasions will be generated in a slot, then there are in total 6 unnecessary redundant HARQ bits for slots N and N+2 in the multiplexed HARQ-ACK codebook 302. This HARQ-ACK codebook construction method leads to a large UCI payload, which wastes the resource and degrades the system performance.

The example embodiments of the present disclosure provide an improved design of Type-1 HARQ-ACK codebook. FIG. 3C illustrates a schematic diagram illustrating an example multiplexed type-1 HARQ codebook 303 according to embodiments of the present disclosure. The HARQ codebook 303 includes HARQ bits 331 to 334 for re-transmitted HARQ feedback and initial HARQ feedback as shown in FIG. 3A. The TDRA list and a set of K1 values configured for the terminal device are the same as the example shown in FIG. 3B. To eliminate the unnecessary redundant HARQ bits, the terminal device 110 may determine a new K1 value for each of retransmitted HARQ-ACK bit, for example, the K1′ value for retransmitted HARQ-ACK bit for PDSCH 312 is the slot offset between the PSDCH 312, and the new indicated PUCCH 320 by the triggering DCI for the HARQ-ACK retransmission. In the example shown in FIG. 3A, K1′=7. The terminal device 110 then determines a new set of K1 values based on the union of the RRC configured set of K1 values and the K1′ value, that is, {1, 3, 5, 7}. Based on the TDRA list and the new set of K1 values, the terminal device 110 may generate the multiplexed HARQ-ACK codebook 303 for retransmitted HARQ-ACK and initial HARQ-ACK as shown in FIG. 3C. This HARQ-ACK codebook construction method can reduce the UCI payload, and thus it is more efficient.

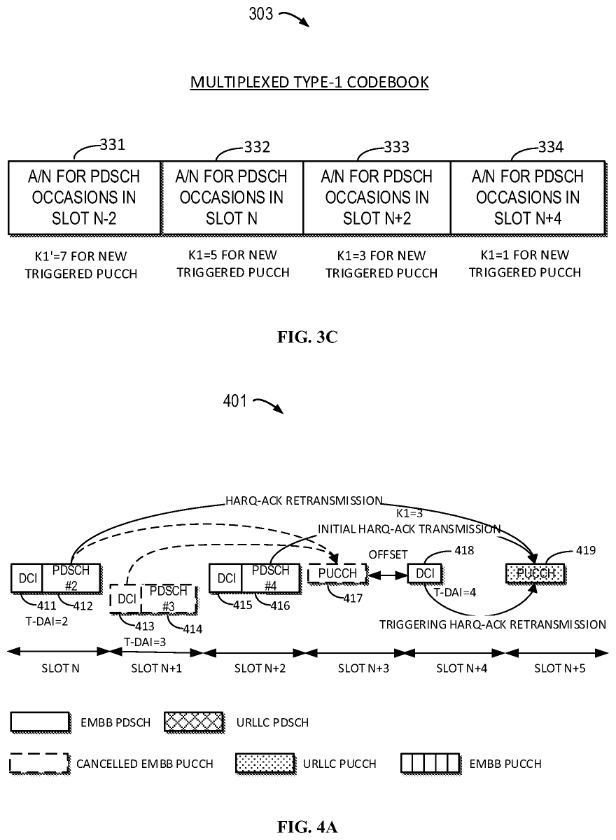

The example embodiments of the present disclosure also provide improvements on a design of Type-2 HARQ-ACK codebook. FIG. 4A illustrates a schematic diagram illustrating another example of multiplexing retransmitted HARQ feedback and initial HARQ feedback on a Type-2 HARQ-ACK codebook and transmitted on the same PUCCH 419 according to embodiments of the present disclosure. The network device 120 transmits PDSCH #1 (not shown), DCI 411 including t-DAI=2 and PDSCH #2 412, DCI 413 including t-DAI=3 and PDSCH #3 414, and DCI 415 with t-DAI=1 and PDSCH #4 416 in sequence to the terminal device 110. The terminal device 110 fails to detect the DCI 413 and thus the terminal device 110 may be unaware of the scheduling of PDSCH #3 414.

As shown in FIG. 4A, the initial transmissions of HARQ feedbacks for PDSCH #1 (not shown), PDSCH #2 412 and PDSCH #3 414 are supposed to be scheduled on PUCCH 417. However, the PUCCH 417 may be cancelled due to collision with a higher priority PUCCH, the network device 120 may determine that retransmission for cancelled HARQ-ACK bits on PUCCH 417 needs to be triggered. In this case, the network device 120 may allocate a new PUCCH 419 for retransmitting the cancelled HARQ-ACK feedback bits. For example, if initial HARQ-ACK for other PDSCH transmission, e.g., PDSCH #4 416 is also indicated to be transmitted on PUCCH 419 or a PUCCH resource overlapped with PUCCH 419, the network device 120 may expect the terminal device 110 to multiplex the HARQ feedbacks for retransmitted HARQ-ACK bits for PDSCH #1 to PDSCH #3 and initial HARQ-ACK bit for PDSCH #4 on a Type-2 HARQ-ACK codebook and transmit the HARQ-ACK codebook on the PUCCH 419.

A simple Type-2 HARQ-ACK codebook construction method at the terminal device 110 is to place the HARQ-ACK codebook for retransmitted HARQ-ACK bits after or before the HARQ-ACK codebook for initial HARQ-ACK bits. Counter DAI (c-DAI) values and total DAI (t-DAI) values are counting separately for the two HARQ-ACK codebooks, and each HARQ-ACK codebook is determined based the corresponding c-DAIs and t-DAIs. However, in case where the DCI miss detections happens, for example, the terminal device 110 fails to detect the DCI 413, then the multiplexed HARQ-ACK codebook includes 2 retransmitted HARQ-ACK bits for PDSCH #1 to PDSCH #2 412 and 1 initial HARQ-ACK bit for PDSCH #4 416. On the other hand, the network device 120 still expects for a HARQ-ACK codebook which includes HARQ-ACK bits for all the four PDSCHs. In other words, the terminal device 110 and the network device 120 may have different understanding on the HARQ-ACK codebook size and the HARQ-ACK bits order for multiplexing retransmitted HARQ-ACK bits and initial HARQ-ACK bits. It will cause the network device 120 cannot decode the HARQ-ACK codebook correctly, leading to a degradation of the reliability performance of data transmission.

To eliminate the size and order ambiguity as discussed above and to improve the design of HARQ-ACK codebook, in some example embodiments, c-DAI values and t-DAI values may be counting separately or jointly for the two HARQ-ACK codebooks for retransmitted HARQ-ACK and initial HARQ-ACK, the DCI 418 for triggering HARQ-ACK retransmission may further include the t-DAI value indicative of a total number of HARQ feedback bits for retransmitted HARQ-ACK and initial transmitted HARQ-ACK. In the example shown in FIG. 4A, t-DAI=4, that is, the HARQ-ACK codebook may include 4 HARQ bits. In some other example embodiments, the DCI 418 may include a plurality of t-DAI values indicating a number of retransmitted HARQ feedback bits and a number of initial HARQ feedback bits respectively. The DAI values may be included in occupied or additional fields in the DCI.

Upon receipt of the DCI 418, the terminal device 110 may construct the type-2 HARQ-ACK codebook including 4 HARQ bits for multiplexed HARQ feedback retransmission and initial HARQ feedback transmission. In this way, even some of DCI is missed or unsuccessfully decoded, the terminal device 110 may determine the size of the HARQ codebook and additionally which of the DCIs is missed based on the t-DAI from the network device 120.

FIG. 4B illustrates a schematic diagram illustrating an example multiplexed type-2 HARQ codebook 402 according to embodiments of the present disclosure. As shown in FIG. 4B, the HARQ codebook 402 includes 4 HARQ bits 421 to 424 each indicating the respective HARQ feedback for PDSCH #1 (not shown) to PDSCH #4. Because the terminal device 110 fails to decode the DCI 413, the HARQ feedback for PDSCH #3 414 is padded with a NACK bit.

FIG. 4C illustrates a schematic diagram illustrating an example of multiplexing HARQ feedback retransmissions on the same PUCCH resource according to embodiments of the present disclosure. As shown in FIG. 4C, the network device 120 transmits PDSCH 441 and 443 to the terminal device 110. The initial HARQ-ACK transmissions for the PDSCH 441 and 443 are supposed to be triggered on PUCCHs 442 and 444. In a case multiple initial HARQ-ACK transmissions are cancelled, for example, both PUCCHs 442 and 444 are cancelled, the network device 120 may multiplex the multiple HARQ-ACK retransmissions on the same PUCCH. For example, the network device 120 may transmit DCI 445 indicating the PUCCH 346 for scheduling the HARQ-ACK retransmissions for PDSCH 441 and 443.

In this case, the DCI 445 may include separate t-DAI values for multiple Type-2 HARQ-ACK codebooks. The t-DAI values may be carried on the extended total DAI fields or on some unused fields in the triggering DCI, e.g., the time domain resource allocation field, frequency domain allocation field, HARQ process number field and so on. Even in case the DCI with a largest DAI value is missing or unsuccessfully decoded by the terminal device 110 the possible ambiguity on the size of the HARQ-ACK codebook between the terminal device 110 and the network device 120 can be removed, thus improving the reliability performance of the communication system.

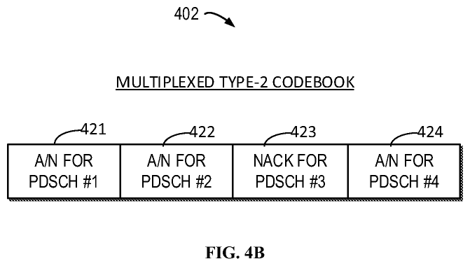

The process 700 is also applicable for SPS HARQ feedback retransmission. FIG. 5 illustrates a schematic diagram illustrating an example of SPS HARQ feedback retransmission 500 according to embodiments of the present disclosure. As shown in FIG. 5, the network device 120 transmits SPS PDSCHs 511 to 513 to the terminal device 110. The corresponding initial HARQ-ACK transmissions for the SPS PDSCHs 511 to 513 are supposed to be triggered on configured grant PUCCH 521 and 522 and PUCCH 523. However, since the PUCCH 523 collides with the DL symbols, the initial HARQ-ACK transmission for SPS PDSCH 513 on PUCCH 523 is cancelled.

In embodiments where dynamic DCI indication for triggering SPS HARQ-ACK retransmission is received from the network device 120, the terminal device 110 may use the PUCCH 541 as indicated in the DCI 531 for HARQ-ACK retransmission for SPS PDSCH 513.

In some other embodiments, the terminal device 110 may determine a PUCCH for HARQ-ACK retransmission for SPS PDSCH 513 based on SPS HARQ-ACK deferral rule. In particular, if the SPS HARQ-ACK deferral rule is enabled, the terminal device 110 may find the next available PUCCH resource (e.g., PUCCH 542) for the HARQ-ACK retransmission for SPS PDSCH 513.

In the embodiments where the dynamic DCI indication for triggering SPS HARQ-ACK retransmission is received while the SPS HARQ-ACK deferral rule is also enabled, it may be specified that a resource determination based on the DCI indication has priority over a resource determination based on SPS HARQ-ACK deferral rule. In other words, in this case, the dynamic DCI 531 indication overrides the SPS HARQ-ACK deferral rule. It provides flexibility for gNB to control the SPS HARQ-ACK retransmission. For example, as shown in the FIG. 5, a PUCCH resource 542 can be determined based on the semi-static SPS HARQ-ACK deferral rule, while gNB may dynamically trigger a PUCCH resource 542 earlier than PUCCH resource 542 for SPS HARQ-ACK retransmission to reduce the latency, which is beneficial for the system performance especially for SPS HARQ-ACK for URLLC traffic.

In the embodiments where the dynamic DCI indication is received while the SPS HARQ-ACK deferral rule is enabled, it may be specified that the resource determination based on the SPS HARQ-ACK deferral rule has priority over the resource determination based on the DCI indication. In this case, when the SPS HARQ-ACK deferral rule is configured to the terminal device 110, the network device 120 may not transmit DCI 531 for scheduling the HARQ-ACK retransmission. In this way, it is simple to remove the ambiguity on the PUCCH resource determination for retransmitted SPS HARQ-ACK at UE side.

In some example embodiments, only one of the SPS HARQ-ACK deferral rule and the dynamic DCI indication is enabled, which may be configured by a signaling between the terminal device 110 and the network device 120.

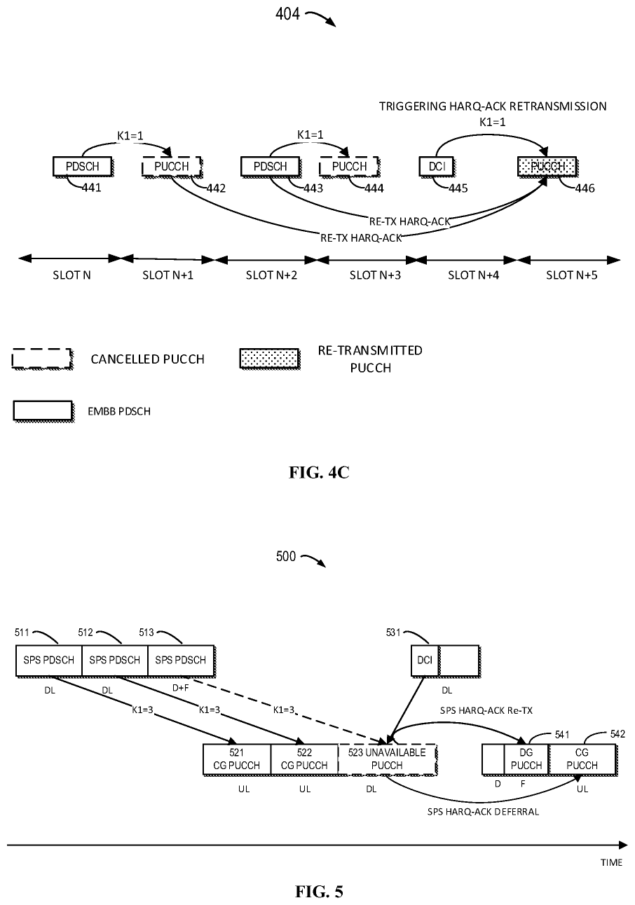

FIG. 6 illustrates a schematic diagram illustrating another example of SPS HARQ feedback retransmission 600 according to embodiments of the present disclosure. As shown in FIG. 6, the terminal device 110 is configured with the SPS HARQ-ACK deferral rule, while the PUCCH resource 616 on CC #1 allocated for initial SPS HARQ-ACK transmission for SPS PDSCH 612 collides with DL symbol or SSB or CORESET #0.

In the above case, the terminal device 110 may determine that the PUCCH resource 616 is unavailable for initial HARQ-ACK transmission, and find the next available PUCCH 619 for HARQ-ACK retransmission for SPS PDSCHS 616 based on the SPS HARQ-ACK deferral rule.

Alternatively, if a PUSCH resource 626 on CC #2 is overlapped with the unavailable PUCCH resource 616, the terminal device 110 may multiplex the HARQ-ACK transmission for SPS PDSCH 613 on the PUSCH 626 on CC #2 instead of following the SPS HARQ-ACK deferral rule to delay the HARQ-ACK transmission for SPS PDSCH 613 on PUCCH 619. It is beneficial to reduce the latency of SPS HARQ-ACK transmission.

Embodiments of the present disclosure provide solutions for solving the above and other potential issues. Generally, an enhanced HARQ feedback mechanism is provided to facilitate the communication between the terminal device and the network device. The mechanism provides a clear definition for out-of-order HARQ-ACK condition for two PUCCH resources for retransmitted HARQ-ACK and new transmitted HARQ-ACK. It also provides a solution for UE to determine the priority between dynamic SPS HARQ-ACK retransmission triggering and semi-static SPS HARQ-ACK deferral rule. Moreover, the HARQ-ACK retransmission for one data transmission can be multiplexed with at least one of HARQ retransmission or initial HARQ-ACK transmission for other data transmissions in the same codebook, and thus less PUCCH transmissions can be achieved. In this way, the spectrum efficiency and system performance can be improved, while an improved multiplexed HARQ-ACK codebook construction method is provided to reduce the overhead for UCI.

### Example Implementation of Methods

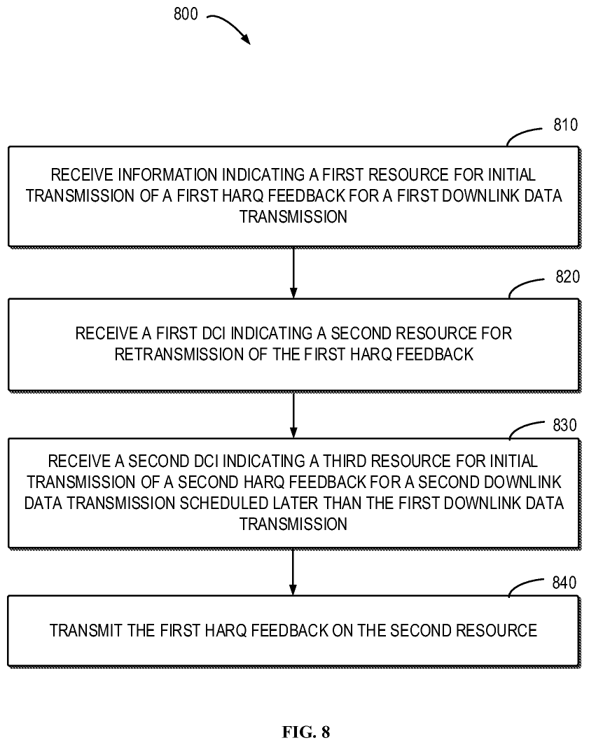

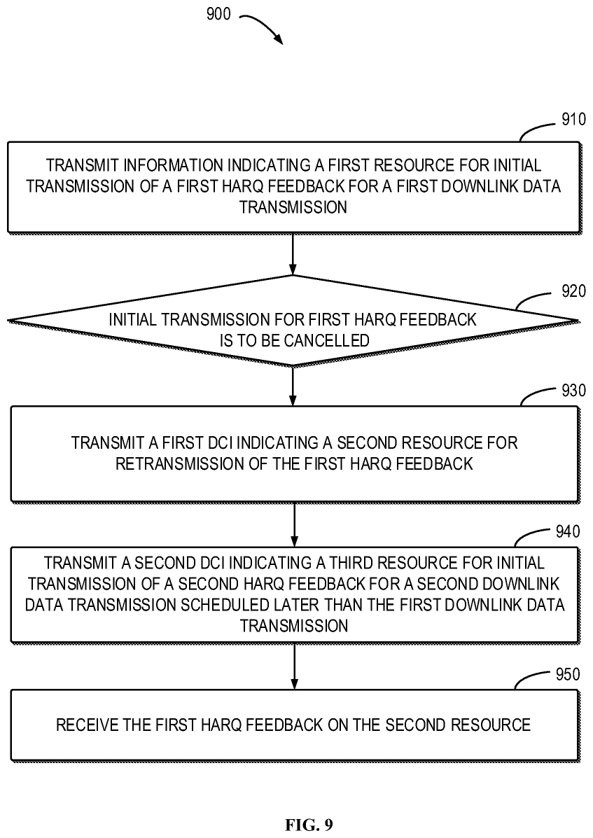

Accordingly, embodiments of the present disclosure provide methods of communication implemented at a terminal device and a network device. These methods will be described below with reference to FIGS. 8-9.

FIG. 8 illustrates an example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At 810, the terminal device 110 receives, from the network device 120, information indicating a first resource for initial transmission of a first Hybrid Automatic Repeat Request (HARQ) feedback for a first data transmission. The first data transmission may comprise a semi-persistent scheduling (SPS) transmission or a dynamic scheduled downlink transmission.

At 820, the terminal device 110 receives, from the network device 120, a first downlink control information (DCI) indicating a second resource for retransmission of the first HARQ feedback.

At 830, the terminal device 110 receives, from the network device 120, a second DCI indicating a third resource for initial transmission of a second HARQ feedback for a second data transmission scheduled later than the first data transmission. The priority of the first HARQ feedback is the same as a priority of the second HARQ feedback.

In some example embodiments, the third resource may be expected to be transmitted later than the first resource.

In some example embodiments, the third resource may be expected to be transmitted not earlier than the second resource.

In some example embodiments, the terminal device 110 may determine that the second resource and the third resource are the same or overlapped in time domain. In this case, the terminal device 110 may cancel the initial transmission of the second HARQ feedback on the third resource.

In some example embodiments, the terminal device 110 may determine that the second resource and the third resource are the same or overlapped in time domain. In this case, the terminal device 110 may cancel the retransmission of the first HARQ feedback on the second resource.

At 840, the terminal device 110 transmits, to the network device 120, the second HARQ feedback on the third resource.

In some example embodiments, the terminal device 110 may determine that that the second resource and the third resource are the same or overlapped in time domain. In this case, the terminal device 110 may generate a HARQ-ACK codebook, and the first HARQ feedback and the second HARQ feedback are multiplexed in the HARQ-ACK codebook. The terminal device 110 may then transmit the HARQ-ACK codebook on the second resource.

In some example embodiments, the second resource may be configured for retransmission of at least one third HARQ feedback for at least one third data transmission, and wherein the HARQ-ACK codebook further comprises the at least one third HARQ feedback.

In the embodiments where the HARQ-ACK codebook is a Type-1 HARQ-ACK codebook, to generate the HARQ-ACK codebook, the terminal device 110 may determine a first K1 value indicating a slot offset between a resource on which the first data transmission is received and the second resource. The terminal device 110 may then determine a target set of K1 values comprising the first K1 value and preconfigured K1 values. The Type-1 HARQ-ACK codebook comprising at least the first HARQ feedback and the second HARQ feedback may be generated based on the target set of K1 values.

In the embodiments where the HARQ-ACK codebook is a Type-2 HARQ-ACK codebook, to generate the HARQ-ACK codebook, the terminal device 110 may generate the Type-2 HARQ codebook comprising at least the first HARQ feedback and the second HARQ feedback based on the first DCI indicating a total number of multiplexed HARQ feedback bits.

In the embodiments where the HARQ-ACK codebook is a Type-2 HARQ-ACK codebook, to generate the HARQ-ACK codebook, the terminal device 110 may generate the Type-2 HARQ codebook comprising at least the first HARQ feedback and the second HARQ feedback based on the first DCI. In these embodiments, the first DCI may comprise a first DCI field indicating a number of retransmission HARQ feedback bits and a second DCI field indicating a number of initial transmission HARQ feedback bits.

In some example embodiments, the first HARQ feedback may be contained in a Type-2 HARQ-ACK codebook, and the terminal device 110 may receive information indicating a fourth resource for initial transmission of a fourth HARQ feedback for a fourth data transmission. If an indication from the first DCI indicates that the second resource is for retransmission of at least the first HARQ feedback and the fourth HARQ feedback, the terminal device 110 may generate the Type-2 HARQ codebook comprising at least the first HARQ feedback and the fourth HARQ feedback based on the first DCI. In these embodiments, the first DCI may comprise a first DCI field indicating a number of the retransmitted first HARQ feedback bits and another DCI field indicating a number of the retransmitted fourth HARQ feedback bits. The first DCI field and the second DCI field may be corresponding to the first x bits and second x bits in total DAI field, or a total DAI field and another indicator field.

In the embodiments where the first data transmission is the SPS transmission, and a SPS HARQ-ACK deferral rule is configured to the terminal device 110, upon receipt of the first DCI, the terminal device 110 may determine that a resource determination based on the first DCI has priority over a resource determination based on the SPS HARQ-ACK deferral rule.

Alternatively, in the embodiments where the first data transmission is the SPS transmission, the resource determination based on the SPS HARQ-ACK deferral rule may has priority over the resource determination based on the first DCI. In this case, when the SPS HARQ-ACK deferral rule is configured to the terminal device 110, the terminal device 110 may find the next available PUCCH resource based on the SPS HARQ-ACK deferral rule and ignore the dynamic DL assignment for triggering the SPS HARQ-ACK retransmission. Then the dynamically triggering HARQ-ACK retransmission by DCI is only applicable for HARQ-ACK for dynamically scheduled PDSCH.

In some example embodiments, only one of the SPS HARQ-ACK deferral rule and the dynamic DCI indication is enabled, which may be configured by a signaling between the terminal device 110 and the network device 120.

In the case as shown in FIGS. 5-6, where the terminal device 110 is configured with the SPS HARQ-ACK deferral rule, and the PUCCH resource on CC #1 that is allocated for SPS HARQ-ACK transmission collides with DL symbol/SSB/CORESET #0, the PUCCH resource is unavailable for HARQ-ACK transmission, if a PUSCH resource on CC #2 is overlapped with the unavailable PUCCH resource.

In some example embodiments, the terminal device 110, when facing the above cases, may follow the SPS HARQ-ACK deferral rule to find the next available PUCCH resource on CC #1 for SPS HARQ-ACK transmission.

In some other example embodiments, the terminal device 110, when facing the above cases, may multiplex the HARQ-ACK on the PUSCH resource on CC #2 instead of following the SPS HARQ-ACK deferral rule.

FIG. 9 illustrates an example method 900 of communication implemented at a network device in accordance with some embodiments of the present disclosure. For example, the method 900 may be performed at the network device 120 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

As shown in FIG. 9, at block 910, the network device 120 transmits, to the terminal device 110, information indicating a first resource for initial transmission of a first HARQ feedback for a first data transmission. For example, the first data transmission may comprise a semi-persistent scheduling (SPS) transmission or a dynamic scheduled downlink transmission.

At block 920, the network device 120 determines whether the first resource for the first HARQ feedback is to be cancelled by the terminal device 110.

If the first resource for the first HARQ feedback is to be cancelled, at 930, the network device 120 transmits, to the terminal device 110, a first DCI indicating a second resource for retransmission of the first HARQ feedback.

In some example embodiments, the second resource may be configured for retransmission of at least one third HARQ feedback for at least one third data transmission, and wherein the HARQ-ACK codebook further comprises the at least one third HARQ feedback.

At 940, the network device 120 transmits, to the terminal device 110, a second DCI indicating a third resource for initial transmission of a second HARQ feedback for a second data transmission scheduled later than the first data transmission. The priority of the first HARQ feedback is the same as a priority of the second HARQ feedback.

In some example embodiments, the third resource may be expected to be transmitted later than the first resource.

In some example embodiments, the third resource may be expected to be transmitted not earlier than the second resource.

At 950, the network device 120 receives, from the terminal device 110, the first HARQ feedback on the second resource.

In some example embodiments, to receive the first HARQ feedback, the network device 120 may receive a HARQ-ACK codebook on the second resource, and the first HARQ feedback and the second HARQ feedback are multiplexed in the HARQ-ACK codebook.

In some example embodiments, the HARQ-ACK codebook may be a Type-1 HARQ-ACK codebook, and the HARQ-ACK codebook is based on a target set of K1 values comprising a first K1 value and preconfigured K1 values, the first K1 value is indicative of a slot offset between a resource on which the first data transmission is transmitted and the second resource.

In some example embodiments, the HARQ-ACK codebook may be a Type-2 HARQ-ACK codebook, and the first DCI indicates a total number of HARQ feedback bits for at least the first HARQ feedback and the second HARQ feedback.

In some example embodiments, the HARQ-ACK codebook may be a Type-2 HARQ-ACK codebook, and the first DCI comprises a first DCI field indicating a number of retransmission HARQ feedback bits and a second DCI field indicating a number of initial transmission HARQ feedback bits.

In some example embodiments, the first HARQ feedback may be contained in a Type-2 HARQ-ACK codebook, and the first DCI may indicate that the second resource is configured for retransmission of at least the first HARQ feedback and the fourth HARQ feedback, the first DCI may comprise a first DCI field indicating a number of retransmission HARQ feedback bits. In these embodiments, the network device 120 may further transmit information indicating a fourth resource for initial transmission of a fourth HARQ feedback for a fourth data transmission.

In the embodiments where the first data transmission is the SPS transmission, a resource determination based on the first DCI has priority over a resource determination based on SPS HARQ-ACK deferral rule. In other words, in this case, the dynamic DCI indication overrides the SPS HARQ-ACK deferral rule.

Alternatively, in the embodiments where the first data transmission is the SPS transmission, the resource determination based on the SPS HARQ-ACK deferral rule has priority over the resource determination based on the first DCI. In this case, when the SPS HARQ-ACK deferral rule is configured to the terminal device 110, the network device 120 may not transmit dynamic DL assignment for scheduling the HARQ-ACK retransmission.

In some example embodiments, only one of the SPS HARQ-ACK deferral rule and the dynamic DCI indication is enabled, which may be configured by a signaling between the terminal device 110 and the network device 120.

In the case as shown in FIGS. 5-6, where the terminal device 110 is configured with the SPS HARQ-ACK deferral rule, and the PUCCH resource on CC #1 that is allocated for SPS HARQ-ACK transmission collides with DL symbol/SSB/CORESET #0, the PUCCH resource is unavailable for HARQ-ACK transmission, if a PUSCH resource on CC #2 is overlapped with the unavailable PUCCH resource.

In some example embodiments, the network device 120, when facing the above cases, may expect that the terminal device 110 will follow the SPS HARQ-ACK deferral rule to find a next available PUCCH resource on CC #1 for SPS HARQ-ACK transmission.

In some other example embodiments, the network device 120, when facing the above cases, may expect that the terminal device 110 will multiplex the HARQ-ACK on the PUSCH resource on CC #2 instead of following the SPS HARQ-ACK deferral rule.

According to the example embodiments of the present disclosure, an enhanced HARQ feedback mechanism is provided. Based on the mechanism, both a dynamic out-of-order HARQ-ACK retransmission and a SPS HARQ-ACK deferral is supported. Moreover, the HARQ-ACK retransmission for one data transmission can be multiplexed with at least one of HARQ retransmission or initial HARQ-ACK transmission for other data transmissions in the same codebook, and thus less redundant bit can be produced. In this way, the spectrum efficiency and system performance can be improved, while the overhead for the UCI can be reduced.

### Example Implementation of Device

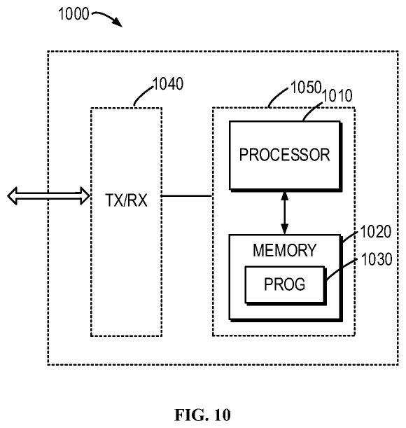

FIG. 10 is a simplified block diagram of a device 1000 that is suitable for implementing embodiments of the present disclosure. The device 1000 can be considered as a further example implementation of the terminal device 110 or the network device 120 as shown in FIG. 1. Accordingly, the device 1000 can be implemented at or as at least a part of the terminal device 110 or the network device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the cNB/gNB, Un interface for communication between the cNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 2 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises circuitry configured to: receive, from a network device, information indicating a first resource for initial transmission of a first Hybrid Automatic Repeat Request (HARQ) feedback for a first data transmission; receive, from the network device, a first downlink control information (DCI) indicating a second resource for retransmission of the first HARQ feedback; receive, from the network device, a second DCI indicating a third resource for initial transmission of a second HARQ feedback for a second data transmission scheduled later than the first data transmission, wherein a priority of the first HARQ feedback is the same as a priority of the second HARQ feedback; and transmit, to the network device, the first HARQ feedback on the second resource.

In some example embodiments, the third resource is expected to be transmitted later than the first resource.

In some example embodiments, the third resource is expected to be transmitted not earlier than the second resource.

In some example embodiments, the circuitry may be further configured to: in accordance with a determination that the second resource and the third resource are the same or overlapped in time domain, cancel the initial transmission of the second HARQ feedback on the third resource.

In some example embodiments, the circuitry may be configured to transmit the first HARQ feedback by: in accordance with a determination that the second resource and the third resource are the same or overlapped in time domain, generating a HARQ-ACK codebook, wherein the first HARQ feedback and the second HARQ feedback are multiplexed in the HARQ-ACK codebook; and transmitting the HARQ-ACK codebook on the second resource.

In some example embodiments, the second resource is configured for retransmission of at least one third HARQ feedback for at least one third data transmission, and wherein the HARQ-ACK codebook further comprises the at least one third HARQ feedback.

In some example embodiments, the HARQ-ACK codebook comprises a Type-1 HARQ-ACK codebook, and the circuitry may be further configured to: determine a first K1 value indicating a slot offset between a resource on which the first data transmission is received and the second resource; determine a target set of K1 values comprising the first K1 value and preconfigured K1 values; and generate the Type-1 HARQ-ACK codebook comprising at least the first HARQ feedback and the second HARQ feedback based on the target set of K1 values.

In some example embodiments, the HARQ-ACK codebook comprises a Type-2 HARQ-ACK codebook, and the circuitry may be further configured to: generate the Type-2 HARQ codebook comprising at least the first HARQ feedback and the second HARQ feedback based on the first DCI indicating a total number of HARQ feedback bits.

In some example embodiments, the HARQ-ACK codebook comprises a Type-2 HARQ-ACK codebook, and the circuitry may be further configured to: generate the Type-2 HARQ codebook comprising at least the first HARQ feedback and the second HARQ feedback based on the first DCI, wherein the first DCI comprises a first DCI field indicating a number of retransmission HARQ feedback bits and a second DCI field indicating a number of initial transmission HARQ feedback bits.

In some example embodiments, the first HARQ feedback is contained in a Type-2 HARQ-ACK codebook, and the circuitry may be further configured to: receive information indicating a fourth resource for initial transmission of a fourth HARQ feedback for a fourth data transmission; and in accordance with an indication from the first DCI that the second resource is indicated for retransmission of at least the first HARQ feedback and the fourth HARQ feedback, generate the Type-2 HARQ codebook comprising at least the first HARQ feedback and the fourth HARQ feedback based on the first DCI, wherein the first DCI comprises a first DCI field indicating a number of retransmission HARQ feedback bits.

In some example embodiments, the first data transmission comprises a semi-persistent scheduling (SPS) transmission, and a SPS HARQ-ACK deferral rule is enabled at the terminal device, and the circuitry may be further configured to: in accordance with receiving the first DCI, determine that a resource determination based on the first DCI has priority over a resource determination based on the SPS HARQ-ACK deferral rule.

In some embodiments, a network device comprises circuitry configured to: transmit, to a terminal device, information indicating a first resource for initial transmission of a first Hybrid Automatic Repeat Request (HARQ) feedback for a first data transmission; in accordance with a determination that the first resource for the first HARQ feedback is to be cancelled, transmit, to the terminal device, a first downlink control information (DCI) indicating a second resource for retransmission of the first HARQ feedback; transmit, to the terminal device, a second DCI indicating a third resource for initial transmission of a second HARQ feedback for a second data transmission scheduled later than the first data transmission, wherein a priority of the first HARQ feedback is the same as a priority of the second HARQ feedback; and receive, from the terminal device, the first HARQ feedback on the second resource.

In some example embodiments, the third resource is expected to be transmitted later than the first resource.

In some example embodiments, the third resource is expected to be transmitted not earlier than the second resource.

In some example embodiments, the circuitry may be configured to receive the first HARQ feedback by: receiving a HARQ-ACK codebook on the second resource, wherein the first HARQ feedback and the second HARQ feedback are multiplexed in the HARQ-ACK codebook.

In some example embodiments, the second resource is configured for retransmission of at least one third HARQ feedback for at least one third data transmission, and wherein the HARQ-ACK codebook further comprises the at least one third HARQ feedback.

In some example embodiments, the HARQ-ACK codebook is a Type-1 HARQ-ACK codebook, and the HARQ-ACK codebook is based on a target set of K1 values comprising a first K1 value and preconfigured K1 values, the first K1 value is indicative of a slot offset between a resource on which the first data transmission is transmitted and the second resource.

In some example embodiments, the HARQ-ACK codebook is a Type-2 HARQ-ACK codebook, and the first DCI indicates a total number of HARQ feedback bits for at least the first HARQ feedback and the second HARQ feedback.

In some example embodiments, the HARQ-ACK codebook is a Type-2 HARQ-ACK codebook, and the first DCI comprises a first DCI field indicating a number of retransmission HARQ feedback bits and a second DCI field indicating a number of initial transmission HARQ feedback bits.

In some example embodiments, the first HARQ feedback is contained in a Type-2 HARQ-ACK codebook, and the first DCI indicates that the second resource is configured for retransmission of at least the first HARQ feedback and the fourth HARQ feedback, the first DCI comprises a first DCI field indicating a number of retransmission HARQ feedback bits, and the circuitry may be further configured to: transmitting information indicating a fourth resource for initial transmission of a fourth HARQ feedback for a fourth data transmission.

In some example embodiments, the first data transmission comprises a semi-persistent scheduling (SPS) transmission, and a resource determination based on the first DCI has priority over a resource determination based on SPS HARQ-ACK deferral rule.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-23. (canceled)

24. A method, performed by a terminal device, the method comprising:
determining a first physical uplink control channel (PUCCH) resource for transmitting a first Hybrid Automatic Repeat Request acknowledgement (HARQ-ACK) codebook,
determining a second PUCCH resource for transmitting the first HARQ-ACK codebook, and
transmitting, to a network device, the first HARQ-ACK codebook with a first HARQ-ACK feedback on the second PUCCH resource,
wherein:
a second HARQ-ACK codebook with a second HARQ-ACK feedback is multiplexed on the second PUCCH resource, a priority of the first HARQ-ACK feedback is the same as a priority of the second HARQ-ACK feedback, and the first HARQ-ACK codebook is placed after the second HARQ-ACK codebook.

25. The method of claim 24, wherein
the second PUCCH resource is determined based on downlink control information (DCI).

26. The method of claim 24, wherein:
the second PUCCH resource is determined based on semi-persistent scheduling (SPS) HARQ-ACK deferral information, and
the second PUCCH resource is determined as a next available PUCCH resource, in a case where the first PUCCH resource overlaps with a downlink symbol.

27. The method of claim 24, wherein:
the second PUCCH resource is determined based on downlink control information (DCI), in a case where both semi-persistent scheduling (SPS) HARQ-ACK deferral information for determining the second PUCCH resource is configured and the DCI indicating the second PUCCH resource is received.

28. The method of claim 24, wherein
the first HARQ-ACK feedback is for a semi-persistent scheduling (SPS) physical downlink shared channel (PDSCH).

29. A method, performed by a network device, the method comprising:
determining a first physical uplink control channel (PUCCH) resource for a first Hybrid Automatic Repeat Request acknowledgement (HARQ-ACK) codebook,
determining a second PUCCH resource for the first HARQ-ACK codebook, and
receiving, from a network device, the first HARQ-ACK codebook with a first HARQ-ACK feedback on the second PUCCH resource,
wherein:
a second HARQ-ACK codebook with a second HARQ-ACK feedback is multiplexed on the second PUCCH resource, a priority of the first HARQ-ACK feedback is the same as a priority of the second HARQ-ACK feedback, and the first HARQ-ACK codebook is placed after the second HARQ-ACK codebook.

30. The method of claim 29, wherein
the second PUCCH resource is determined based on downlink control information (DCI).

31. The method of claim 29, wherein:
the second PUCCH resource is determined based on semi-persistent scheduling (SPS) HARQ-ACK deferral information, and
the second PUCCH resource is determined as a next available PUCCH resource, in a case where the first PUCCH resource overlaps with a downlink symbol.

32. The method of claim 29, wherein:
the second PUCCH resource is determined based on downlink control information (DCI), in a case where both semi-persistent scheduling (SPS) HARQ-ACK deferral information for determining the second PUCCH resource is configured and the DCI indicating the second PUCCH resource is received.

33. The method of claim 29, wherein
the first HARQ-ACK feedback is for a semi-persistent scheduling (SPS) physical downlink shared channel (PDSCH).

34. A terminal device, comprising a processor configured to cause the terminal device to:
determine a first physical uplink control channel (PUCCH) resource for transmitting a first Hybrid Automatic Repeat Request acknowledgement (HARQ-ACK) codebook,
determine a second PUCCH resource for transmitting the first HARQ-ACK codebook, and
transmit, to a network device, the first HARQ-ACK codebook with a first HARQ-ACK feedback on the second PUCCH resource,
wherein:
a second HARQ-ACK codebook with a second HARQ-ACK feedback is multiplexed on the second PUCCH resource, a priority of the first HARQ-ACK feedback is the same as a priority of the second HARQ-ACK feedback, and the first HARQ-ACK codebook is placed after the second HARQ-ACK codebook.

35. The terminal device of claim 34, wherein
the second PUCCH resource is determined based on downlink control information (DCI).

36. The terminal device of claim 34, wherein:
the second PUCCH resource is determined based on semi-persistent scheduling (SPS) HARQ-ACK deferral information, and
the second PUCCH resource is determined as a next available PUCCH resource, in a case where the first PUCCH resource overlaps with a downlink symbol.

37. The terminal device of claim 34, wherein:
the second PUCCH resource is determined based on downlink control information (DCI), in a case where both semi-persistent scheduling (SPS) HARQ-ACK deferral information for determining the second PUCCH resource is configured and the DCI indicating the second PUCCH resource is received.

38. The terminal device of claim 34, wherein
the first HARQ-ACK feedback is for a semi-persistent scheduling (SPS) physical downlink shared channel (PDSCH).
